(19) United States
(12) Patent Application Publication
(10) Pub. No.: US 2007/0231252 A1
(43) Pub. Date: Oct. 4, 2007

(54) Methods of producing hydrogen using nanotubes and articles thereof

(76) Inventors: James F. Loan, Bellows Falls, VT (US); William K. Cooper, Santa Fe, NM (US); Christopher H. Cooper, Windsor, VT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/642,759

(22) Filed: Dec. 21, 2006

Related U.S. Application Data
(60) Provisional application No. 60/752,407, filed on Dec. 22, 2005.

(51) Int. Cl. C01B 3/02

(52) U.S. Cl. 423/648.1; 422/129; 422/198; 422/225; 977/742

(57) ABSTRACT

Disclosed herein is a method of generating hydrogen that comprises forming a mixture of a hydrogen containing compound and a nanotube containing material, and dissociating hydrogen by exposing the mixture to activation energy. Also disclosed are articles for generating hydrogen comprising a container for holding the hydrogen containing compound and nanotube containing material, optionally comprising at least one inlet for applying activation energy.

This application claims the benefit of domestic priority to U.S. Provisional Patent Application Ser. No. 60/752,407, filed Dec. 22, 2005, which is herein incorporated by reference in it's entirety.

Disclosed herein are methods of generating hydrogen using nanotubes, such as carbon nanotubes, a hydrogen containing source, such as water, in the presence of an activation source. Also disclosed are devices for practicing the disclosed methods.

A need exists for alternative energy sources to alleviate our society's current dependence on hydrocarbon fuels without further negative impact on the environment. For example, an economical and safe method of producing hydrogen would be beneficial.

The Inventors have developed multiple uses for carbon nanotubes and devices that use carbon nanotubes. In one embodiment, the present disclosure combines the unique properties of carbon nanotubes in a novel manifestation designed to meet current and future energy needs in an environmentally friendly way, namely through the production of hydrogen.

### SUMMARY OF INVENTION

Accordingly, there is disclosed a method of generating hydrogen comprising bringing nanotubes, such as carbon nanotubes, into contact with a hydrogen containing source in the present of activation energy. In one embodiment, the described method is performed at room temperature. One non-limiting source of hydrogen is a compound, such as H₂O.

Also disclosed in a device for generating hydrogen through the dissociation of a hydrogen containing source in the presence of a nanotube containing material. In this embodiment, the device comprises at least one container for holding a mixture of the hydrogen containing source, such as water, and the nanotube containing material, and optionally comprises at least one inlet for providing activation energy to the mixture.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic of a hydrogen producing wet cell according to one embodiment of the present disclosure that uses a water/carbon nanotube mixture activated by light absorption.

FIG. 2 is a schematic of a hydrogen producing wet cell according to one embodiment of the present disclosure that uses a deuterium/carbon nanotube mixture activated by energy supplied via an electric field to platinum electrodes.

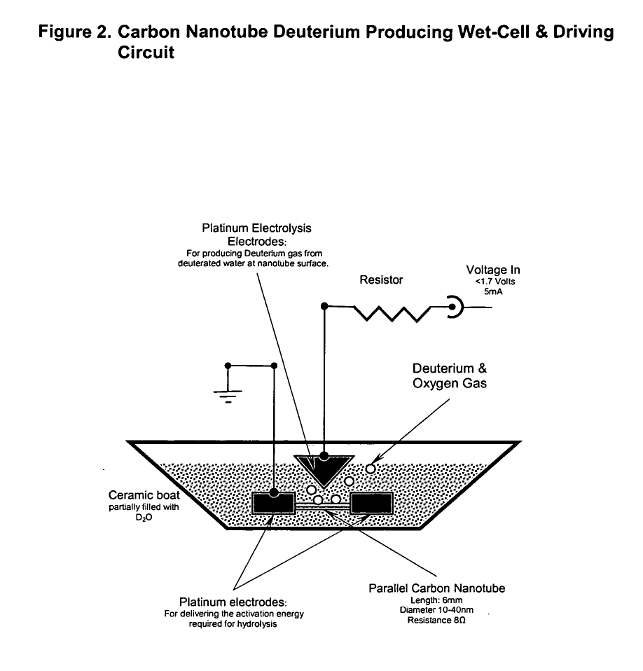

### DETAILED DESCRIPTION OF THE INVENTION

A. Definitions

The following terms or phrases used in the present disclosure have the meanings outlined below:

The term “fiber” or any version thereof, is defined as an object of length L and diameter D such that L is greater than D, wherein D is the diameter of the circle in which the cross section of the fiber is inscribed. In one embodiment, the aspect ratio L/D (or shape factor) of the fibers used may range from 2:1 to 10⁹:1. Fibers used in the present disclosure may include materials comprised of one or many different compositions.

The term “nanotube” refers to a tubular-shaped, molecular structure generally having an average diameter in the inclusive range of 25 Å to 100 nm. Lengths of any size may be used.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The term “double-walled carbon nanotube” refers to an elongated solenoid of a carbon nanotube described having a closed carbon cage but at least one open end.

The phrase “environmental background radiation” refers to radiation emitted from a variety of natural and artificial sources including terrestrial sources and cosmic rays (cosmic radiation).

The term “functionalized” (or any version thereof) refers to a nanotube having an atom or group of atoms attached to the surface that may alter the properties of the nanotube, such as its zeta potential.

The term “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

The term “plasma” refers to an ionized gas, and is intended to be a distinct phase of matter in contrast to solids, liquids, and gases because of its unique properties. “Ionized” means that at least one electron has been dissociated from a proportion of the atoms or molecules. The free electric charges typically make the plasma electrically conductive so that it responds strongly to electromagnetic fields.

The term “supercritical” (when used with “phase” or “fluid”) is defined as any substance at a temperature and pressure above its thermodynamic critical point. It has the unique ability to diffuse through solids like a gas, and dissolve materials like a liquid. Additionally, it can readily change in density upon minor changes in temperature or pressure. In one embodiment, water can be in a supercritical phase.

The term “container” refers to any vessel or environment sufficient to contain the carbon nanotubes and water. For example, in one embodiment, the container may comprise physical containers with finite volume, such as quartz or Pyrex glass ware. In another embodiment, the container may comprise non-physical containers having soft boundaries, such as an electromagnetic field. In another embodiment the nanotubes are incorporated into a pores media and laminated between a thin layer of material on one side and an optically transparent material on the other.

In one embodiment, the production of hydrogen may require the addition of activation energy. This activation energy may come in the form of electromagnetic stimulation either directly or indirectly which imparts changes in temperatures, or electromagnetic fields to the hydrogen containing compound. The initial activation energy may be in the form of a current pulse or electromagnetic radiation.

In another embodiment, solar radiation is adsorbed by the carbon nanotube and is used to perform hydrolysis.

In one embodiment, the method for producing hydrogen from a hydrogen containing source or compound, such as water, in the presence of nanotubes utilizes activation energy in the form of thermal, electromagnetic, or the kinetic energy of a particle. Electromagnetic energy comprises one or more sources chosen from x-rays, optical photons, α, β, or γ-rays, microwave radiation, infrared radiation, ultraviolet radiation, photons, cosmic rays, radiation in the frequencies ranging from gigahertz to terahertz, or combinations thereof. The foregoing forms of radiation may be coherent or not coherent, or combined in any combination thereof.

The activation energy may also comprise particles with kinetic energy, which are defined as any particle, such as an atom or molecule, in motion. Non-limiting embodiments include protons, neutrons, anti-protons, elemental particles, and combinations thereof. As used herein, “elemental particles” are fundamental particles that cannot be broken down to further particles. Examples of elemental particles include electrons, anti-electrons, mesons, pions, hadrons, leptons (which is a form of electron), baryons, radio isotopes, and combinations thereof.

Other particles that may be used as activation energy in the disclosed method include those mentioned by reference at pages 460-494 of “Modern Physics” by Hans C. Ohanian, which pages are herein incorporated by reference. Without being bound by any theory the methods for producing hydrogen described herein are a manifestation, at least in part, to the nanotube structure. It is believed that when matter on the atomic scale is confined to the limited dimensions of a nanotube structure, the ability to remove a hydrogen from its source is greatly increased. For example, in one embodiment, nanoscale confinement increases the probabilities that water can be split.

Confirmation of this theory is described in an article published subsequent to the present invention. In particular, the article by Guo et al., Visible-Light-Induced Water Splitting in Channels of Carbon Nanotubes, J. Phys. Chem. B 2006,110, 1571-1575 (published on the Web on Jan. 07, 2006), which is herein incorporated by reference, describes the splitting of water confined to a single-water carbon nanotube by exposing it to a visible light flash. While this article describes a fundamentally different mechanism, particularly one that relies on high vacuum, it nonetheless shows that hydrogen can be generated when a mixture comprising a hydrogen containing source and carbon nanotubes are exposed to activation energy.

Thus, one embodiment of the present disclosure is directed to producing a hydrogen gas (H₂) by confining a source of hydrogen, such as water, in a carbon nanotube and applying an appropriate activation energy thereto.

Other hydrogen containing sources that may be used in the present disclosure comprise compounds chosen from water, deuterated water, tritiated water, hydrocarbons or combinations thereof.

While carbon nanotubes are used in one particular embodiment, any nanoscaled structure having a hollow interior that assists or enables nanoscale confinement, and that does not adversely interact with the hydrogen containing compound can be used in the disclosed process. For example, in one embodiment the nanotube comprises carbon nanotube, such as a multi-walled carbon nanotube having a length ranging from 500 μm to 10 cm, such as from 2 mm to 10 mm. Nanotube structures according to the present disclosure may have an inside diameter ranging up to 100 nm, such as from 25 Å to 100 nm.

While the nanotubes described herein may comprise carbon and its allotropes, the nanotube material may also comprise a non-carbon material, such as an insulating, metallic, or semiconducting material, or combinations of such materials.

In one embodiment, the nanotubes may be aligned end to end, parallel, or in any combination there of. In addition, or alternatively, the nanotubes may be fully or partially coated or doped by least one atomic or molecular layer of an inorganic material.

In one embodiment, the dissociation reaction occurs within the walls of a multi-walled nanotube (when used), or located within the interior of the nanotube. Dissociation may also occur outside the nanotube with the nanotube acting as a catalyst.

The method described herein may further comprise agitating the hydrogen containing source and nanotubes prior to or doing the process. Mechanical agitation may be used to release gas phase bubbles from the surface of the nanotubes, so that the reaction does not become self-limiting.

The composition of the nanotube is not known to be critical to the methods described herein. Without being bound by theory, and as previously stated, the confinement of the species within the nanotube may be responsible for the effects that are disclosed herein, rather than some interaction of the carbon in the nanotubes used in the disclosed embodiment and the species that was energized by the confinement, deuterium. For this reason, while the nanotubes describe herein are specifically described as carbon, more generally, they can comprise ceramic (including glasses), metallic (and their oxides), organic, and combinations of such materials.

Like the composition, the morphology (geometric configuration) of the nanotubes, other than providing confinement in a dimension for the species being energized, is not known to be critical. In one embodiment, the disclosure utilizes a multi-walled, carbon nanotube. The nanotube structure disclosed herein may have single or multiple atomic or molecular layers forming a shell or coating on the nanotubes described herein. For example, the nanotube structure disclosed herein may have one or more epitaxial layers of metals or alloys on at least one of its surfaces. In addition to such coatings, the nanotube structure may be doped by least one atomic or molecular layer of an inorganic or organic material.

A description of coatings for nanotubes, as well as methods of coating nanotubes, are described in Applicants' following co-pending applications, which are herein incorporated by reference in their entireties: U.S. patent application Ser. No. 11/111,736, filed Apr. 22, 2005, U.S. patent application Ser. No. 10/794,056, filed Mar. 8, 2004 and U.S. patent application Ser. No. 11/514,814, filed Sep. 1, 2006.

The method described herein may further comprise functionalizing the carbon nanotubes with at least one organic group. Functionalization is generally performed by modifying the surface of carbon nanotubes using chemical techniques, including wet chemistry or vapor, gas or plasma chemistry, and microwave assisted chemical techniques, and utilizing surface chemistry to bond materials to the surface of the carbon nanotubes. These methods are used to “activate” the carbon nanotube, which is defined as breaking at least one C—C or C-heteroatom bond, thereby providing a surface for attaching a molecule or cluster thereto.

Functionalized carbon nanotubes may comprise chemical groups, such as carboxyl groups, attached to the surface, such as the outer sidewalls, of the carbon nanotube. Further, the nanotube functionalization can occur through a multi-step procedure where functional groups are sequentially added to the nanotube to arrive at a specific, desired functionalized nanotube.

Unlike functionalized carbon nanotubes, coated carbon nanotubes are covered with a layer of material and/or one or many particles which, unlike a functional group, is not necessarily chemically bonded to the nanotube, and which covers a surface area of the nanotube.

Carbon nanotubes used herein may also be doped with constituents to assist in the disclosed process. As stated, a “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

In any embodiment the nanotubes may be held in an aquatic suspension, magnetic field, electric field, electromagnetic fields, mechanical nanotube networks, mechanical networks including nanotubes and other fibers, networks of nanotubes formed into non-woven materials, networks formed into woven materials or any combination there of.

It is understood that the nanotube structure may comprise a network of nanotubes which are optionally in a magnetic, electric, or otherwise electromagnetic field. In one non-limiting embodiment, the magnetic, electric, or electromagnetic field can be supplied by the nanotube structure itself.

Also disclosed herein is a device for generating hydrogen gas. In one embodiment, the device comprises at least one container for holding the described mixture of a hydrogen containing compound and nanotube containing material.

In one embodiment, the container is sufficient to hold the mixture in an aquatic suspension, a gaseous form, a magnetic field, an electric field, an electromagnetic field, or combinations thereof.

Furthermore chemical dissociation of the hydrogen containing compound typically requires an activation energy, which is described as the energy required to break the chemical bond between atoms within a molecule. This energy is first captured by the nanotube then converted to an electric field. This electric field can be quite large due to the nano-radius of the nanotube. The polar molecule of water will respond to the electric field and disassociate. The dissociation may occur outside the nanotubes, between the walls of multi-nanotubes, or within the hollow center of nanotubes.

As light is adsorbed by a conducting nanotube it induces and electromotive force (EMF). This induced EMF moves charges inside the conduction band of the nanotubes creating a charge separation. This charge separation results in an electric field which can act on the water molecules. Also depending on the work function of the nanotube electrons may be emitted from their ends, providing a source of electrons to neutralize the H⁺ ions resulting in the production of H₂ gas.

In another embodiment water is taken into the hollow core of the nanotube where it is then subjected to the ionizing radiation of electrons. One mode of conduction inside a nanotube is the ballistic transport of electrons down the interior of the nanotube. This can occur when current is induced due to radiation capture.

To increase the dissociation rate, one may simply apply more energy to the nanotube which increases the population of electrons inside the nanotube. Details of nanotube conduction mechanisms are described in “Physical Properties of Carbon Nanotubes”, (2003) by R. Saito, G. Dresselhaus, M. S. Dresselhaus, which is incorporated by reference.

Thus, in one embodiment, the device comprises at least one inlet for providing activation energy to the mixture, and at least one electrode capable of contacting the nanotube containing material. For example, the at least one electrode is used to apply an alternating current, direct current, current pulses, or combinations thereof, to the nanotube structure. In one embodiment, the electrodes are platinum.

It is noted, however, that the device does not always require an inlet for activation energy. Rather, as activation energy may be in the form of environmental background radiation, cosmic rays, sunlight, and other forms not connected to an external source, the device simply requires the ability to receive and capture such energy. For example, in one embodiment, the device is glass-based, such as made of quartz or Pyrex™, that allows light to pass through to the previously described mixture, and thus does not necessarily require electrodes to be connected to at least one of the nanotube containing material or the mixture.

In addition, while the device typically operates at atmospheric pressure, it is appreciated that the use of a liquid or gaseous hydrogen containing compound may require it to be appropriately sealed to prevent escape or discharge of the mixture.

In another embodiment, the device is configured to allow the mixture to be at positive pressure inside the device. This is particularly useful when the hydrogen containing compound is in an a gaseous form.

In an alternative embodiment, the device is configured such that it contains a mechanism for using the dissociated hydrogen directly to power a system, such as a fuel cell, an engine, a turbine, a motor, an electrical device, a thermo-electrical device, a light or light amplification device, or any combination thereof. The devices that require power can be part of a larger assembly of devices such as those in a car, a computer, a robot or an aircraft.

The present disclosure is further illustrated by the following non-limiting example, which is intended to be purely exemplary of the disclosure.

### EXAMPLE

### Dissociation of Water Using a Light Activated Wet Cell

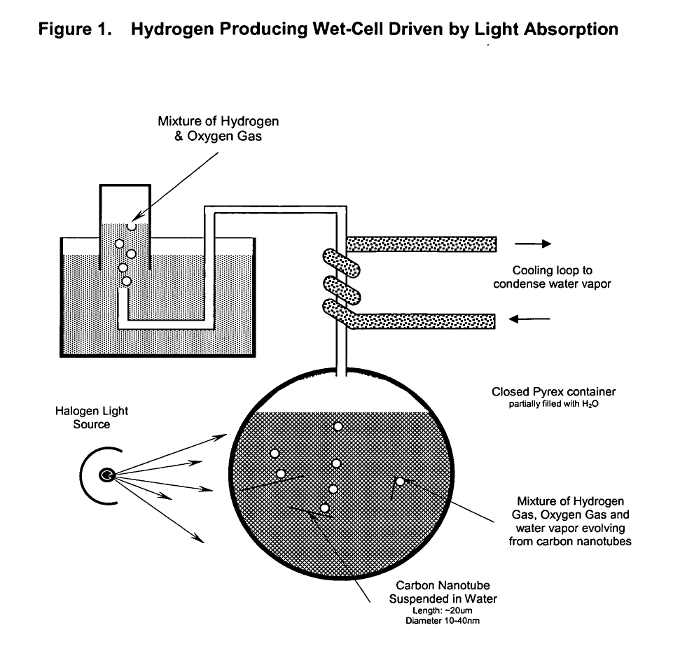

A schematic of the wet-cell used according to this Example is shown in FIG. 1. As shown in this figure, 5 mg of multi-walled carbon nanotubes having lengths averaging about 20 μm and diameters ranging from 10 to 40 nm were dispersed in 250 ml of water in a glass beaker to form a mixture.

The mixture was transferred to a closed Pyrex™ container, which was attached, via glass tubing, to a vessel for capturing resulting gases (“capture vessel”). To prevent the flow of unwanted elements, such as water vapor, to the capture vessel, it was trapped prior to starting the experiment. In particular, as shown in FIG. 1, the tubing that connected the Pyrex™ container and the capture vessel was wrapped with a cold water loop to condense any water resulting from the mixture, and thus prevent it from passing to the capture vessel.

The reaction was initiated by turning on a 500 Watt unshielded halogen bulb (having a back-reflector) that was positioned about 2 feet from the Pyrex™ container. The dissociation of the water in the initial mixture was almost immediately measurable in the capture vessel. After being exposed to the light source for about 3.5 hours, approximately 20 ml of hydrogen gas and 10 ml of oxygen gas was produced in the capture vessel.

This example shows that by exposing a mixture comprising a hydrogen containing source, such as water, and multi-walled carbon nanotubes to an activation energy described herein, the hydrogen containing source can be dissociated to form at least a hydrogen gas.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the invention as approximations, the numerical values set forth in the specific examples are reported as precisely as possible. Any numerical value, however, inherently contains certain errors necessarily resulting from the standard deviation found in its respective testing measurement.

What is claimed is:

1. A method of generating hydrogen, said method comprising:
forming a mixture of a hydrogen containing compound and a nanotube containing material, and
exposing said mixture to activation energy to dissociate hydrogen located in said hydrogen containing compound.

2. The method of claim 1, wherein said hydrogen containing source is compound chosen from water, deuterated water, tritiated water, hydrocarbons or combinations thereof.

3. The method of claim 1, wherein said activation energy comprises thermal energy, electromagnetic energy, or the kinetic energy of a particle or any combination thereof.

4. The method of claim 3, wherein said electromagnetic energy comprises one or more sources chosen from x-rays, optical photons, γ-rays, microwave radiation, infrared radiation, ultraviolet radiation, phonons, radiation in the frequencies ranging from gigahertz to terahertz, or combinations thereof.

5. The method of claim 1, wherein the activation energy comprises environmental background radiation.

6. The method of claim 3, wherein said particle containing kinetic energy is chosen from neutrons, protons, electrons, beta radiation, alpha radiation, mesons, pions, hadrons, leptons, baryons, and combinations thereof.

7. The method of claim 1, wherein said nanotube comprises carbon nanotubes.

8. The method of claim 7, wherein said carbon nanotubes are single walled, multi-walled or combinations thereof.

9. The method of claim 7, wherein said carbon nanotube have a length ranging from 10 nm to 10 m.

10. The method of claim 1, wherein said nanotube has an inside diameter up to 100 nm.

11. The method of claim 1, wherein said mixture is mechanically agitated prior to or simultaneous while exposing the mixture to said activation energy.

12. The method of claim 1, wherein said hydrogen source is in a solid, liquid, gas, plasma, or supercritical phase.

13. The method of claim 1, wherein the said nanotube is comprised of insulating, metallic, or semiconducting materials and combinations of such materials.

14. The method of claim 1, wherein said nanotube containing material comprises a dispersion of nanotubes, a network of nanotubes that is mechanically bonded, or a combination thereof.

15. The method of claim 14, wherein said network of nanotubes are combined with other fibers prior to being contacted with said hydrogen containing compound.

16. The method of claim 14, wherein said network of nanotubes comprises at least one woven, or non-woven nanotube material.

17. The method of claim 1, further comprising powering a device by using the dissociated hydrogen, other byproducts of the dissociation or combinations there of.

18. The method of claim 17, wherein said device is chosen from a fuel cell, an engine, a turbine, a motor, an electrical device, a thermo-electrical device, a light or light amplification device, a heater or any combination thereof.

19. The method of claim 1, wherein said method is performed at atmospheric pressure.

20. A device for generating hydrogen through the dissociation of a hydrogen containing source in the presence of a nanotube containing material,
said device comprising at least one container for holding a mixture of said hydrogen source and said nanotube containing material.

21. The device of claim 20, further comprising at least one inlet for providing activation energy to said mixture.

22. The device of claim 20, wherein said inlet comprises at least one electrode capable of contacting at least said nanotube containing material.

23. The device of claim 20, wherein said container is sufficient to hold said mixture in an aquatic suspension, a magnetic field, an electric field, an electromagnetic field, or combinations thereof.

24. The device of claim 20, wherein said nanotube containing material comprises a dispersion of nanotubes, a network of nanotubes that is mechanically bonded, or a combination thereof.

25. The device of claim 24, wherein said network of nanotubes are combined with other fibers prior to being contacted with said hydrogen containing compound.

26. The device of claim 24, wherein said network of nanotubes comprises at least one woven, or non-woven nanotube material.

27. The device of claim 20, further comprising a mechanical agitator for agitating said mixture.

28. The device of claim 20, further comprising a vessel for capturing said dissociated hydrogen.

29. The device of claim 28, wherein said vessel is connected to said container by at least one tubular conduit.

30. The device of claim 29, wherein said tubular conduit has at least one cooling mechanism attached thereto or there-around.

31. The device of claim 29, wherein at least one of said tubing, vessel, or container consists essentially of a glass.

32. The device of claim 20, further comprising a source of activation energy adjacent to said container.

33. The device of claim 32, wherein said source of activation energy comprises a halogen lamp.
